(19) United States
(12) Patent Application Publication
(10) Pub. No.: US 2020/0054424 A1
(43) Pub. Date: Feb. 20, 2020

(54) FLOSSER PACKAGE

(71) Applicant: Ranir, LLC, Grand Rapids, MI (US)

(72) Inventor: John D. Hall, Grand Rapids, MI (US)

(21) Appl. No.: 16/102,889

(22) Filed: Aug. 14, 2018

(51) Int. Cl. A61C 15/04

(52) U.S. Cl. CPC A61C 15/043; A61C 15/046

(57) ABSTRACT

The present invention provides a flosser package that enables convenient storage, dispensing and disposal of oral care devices such as dental flossers. The flosser package includes a container with both a dispensing cavity and a disposal cavity. A lid covers at least a portion of the container and includes a dispensing portion and a disposal portion separate from said dispensing portion, the dispensing portion selectively provides access to one or more flosser flossers within the dispensing cavity and the disposal portion includes a disposal slot in communication with the disposal cavity and capable of receiving one of the flossers after it has been used. When finished with the flosser, the user can simply place the used flosser in the disposal slot such that it falls into the separate disposal cavity without contacting any of the unused flossers in the dispensing cavity.

### BACKGROUND OF THE INVENTION

The present invention is directed to packaging for holding and storing oral care devices, and more particularly to a package for conveniently containing, selling and using oral care devices such as disposable dental flossers.

Disposable oral care devices, such as toothpicks, flossers, and in some cases toothbrushes are quite common as consumers desire convenient and sanitary, single-use products. In most cases, the packaging for these devices is overlooked. Most commonly, these devices are sold in sealed bags, often re-sealable bags, that enable a user to remove one or more of the devices for use and eventual disposal.

Disadvantages arise with the typical packaging, especially when consumers want access to these devices when on the go, for example, in the car or otherwise during travel, because there may not be immediate access to a place for disposing the used device.

### SUMMARY OF THE INVENTION

The present invention provides a flosser (or other oral care device) package that enables convenient storage, dispensing and disposal of oral care devices such as dental flossers.

In one embodiment, the flosser, or other oral care device, package includes both a dispensing cavity and a disposal cavity. A lid covers at least a portion of the container and the lid includes a dispensing portion and a disposal portion separate from said dispensing portion, the dispensing portion selectively provides access to one or more flossers (or other product) within the dispensing cavity and the disposal portion includes a disposal slot in communication with the disposal cavity and capable of receiving one of the flossers (or other product) after it has been used.

Although the present invention may be used with a variety of oral care devices or other consumer products, in one embodiment the container is designed for a plurality of flossers within the dispensing cavity, each flosser including a handle, a pair of flosser arms extending from the handle, and a strand of floss extending between the flosser arms. The dispensing cavity may be divided from the disposal cavity, wherein the plurality of flossers are disposed within the dispensing cavity and wherein the disposal slot is in communication with the disposal cavity. In one embodiment, the dispensing cavity and the disposal cavity are positioned side by side, and the container may include a container wall separating the dispensing cavity from the disposal cavity. In another embodiment, the dispensing cavity is positioned above the disposal cavity, for example, the dispensing cavity may be formed by a dispensing container that is nested (or partially nested) within a disposal container that forms the disposal cavity.

The lid dispensing portion may be hinged to provide selective access to the dispensing cavity, and it may be movable between an open position providing access to the dispensing cavity and a closed position covering the dispensing cavity. The lid may also include a sidewall having a rim, wherein the container has an upper edge and the rim interfits with the upper edge. The lid may include a lid wall aligned with the container wall when the lid is interfitted with the container, and in one embodiment the dispensing portion is positioned on a first side of the lid wall and the disposal portion on a second side of the lid wall.

In one embodiment, the flosser package is designed for convenient dispensing of the dental flossers, wherein the bottom of the container within the dispensing cavity is positioned to support the plurality of dental flossers such that a portion each of the flossers is at or above said upper edge of said container sidewall.

The container may be cylindrical, such that it can be conveniently placed in a cup holder, such as an automobile cup holder. The hinged portion of the lid and the arrangement of the flossers in the dispensing cavity makes it easy for a user to flip the lid open and remove one or more flossers. When finished with the flosser, the user can simply place the used flosser in the disposal slot such that it falls into the separate disposal cavity without contacting any of the unused flossers in the dispensing cavity.

### BRIEF DESCRIPTION OF THE DRAWINGS

FIG. 1 is a perspective view of a flosser package system according to one embodiment of the present invention with a hinged dispensing lid in an open position and a dispensing portion filled with flossers.

FIG. 2 is a perspective view thereof with the hinged dispending lid in a closed position.

FIG. 3 is a front view thereof with the hinged dispensing lid in the open position.

FIG. 4 is a cross sectional view taken along line A-A in FIG. 3.

FIG. 5 is a top view of the flosser package with the hinged dispensing lid in the open position.

FIG. 6 is a perspective view of a lid according to one embodiment with a hinged dispensing lid in an open position.

FIG. 7 is a perspective view thereof with the lid in a closed position.

FIG. 8 is a perspective view of a container portion of a flosser package according to one embodiment.

FIG. 9 is a top view thereof.

FIG. 10 is a perspective view of a flosser package system according to an alternative embodiment.

FIG. 11 is a side view thereof with a dispensing container in a partially nested position.

FIG. 12 is a front view thereof.

FIG. 13 is a cross sectional view taken along ling B-B in FIG. 12.

FIG. 14 is a perspective view of a lid according to the alternative embodiment.

FIG. 15 is a top view thereof.

FIG. 16 is a side view thereof.

FIG. 17 is a front view thereof.

FIG. 18 is a cross sectional view taken along line A-A in FIG. 17.

FIG. 19 is a bottom view thereof.

FIG. 20 is a top view of a disposal container according to the alternative embodiment.

FIG. 21 is a side view thereof.

FIG. 22 is a front view thereof.

FIG. 23 is a cross sectional view taking along line A-A in FIG. 22.

FIG. 24 is a perspective view of the package according to the second embodiment with the dispensing container in a partially nested position and with a pair of hinged covers open.

FIG. 25 is a side view thereof.

FIG. 26 is a front view thereof.

FIG. 27 is a cross sectional view taken along line B-B in FIG. 26.

### DETAILED DESCRIPTION OF THE CURRENT EMBODIMENTS

### I. Overview

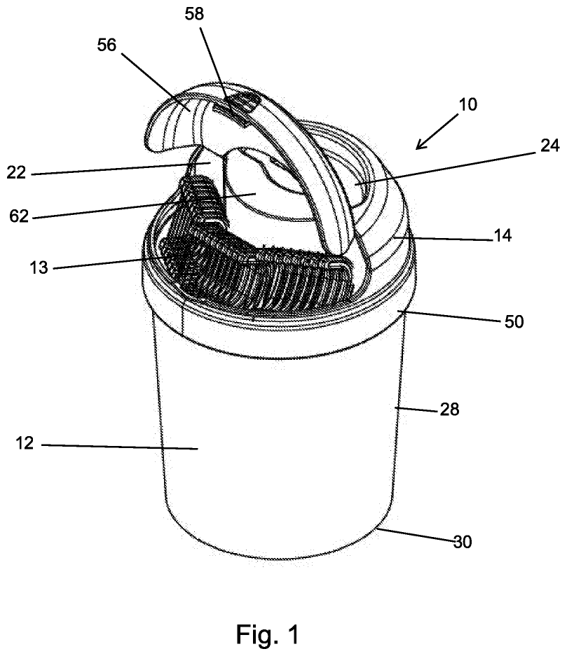

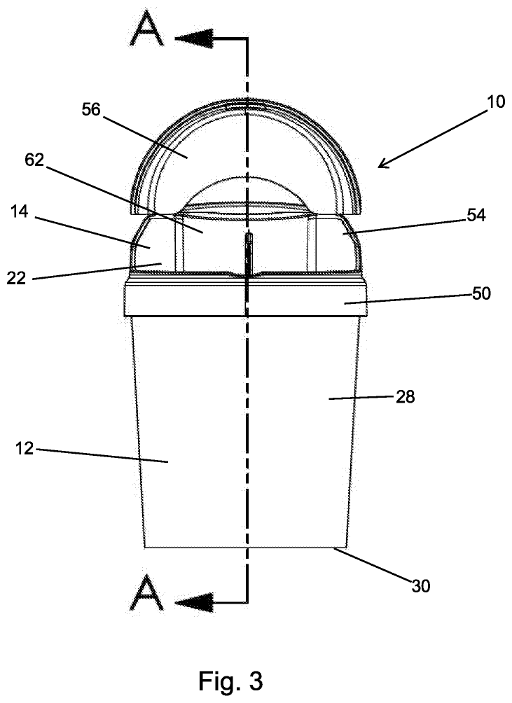

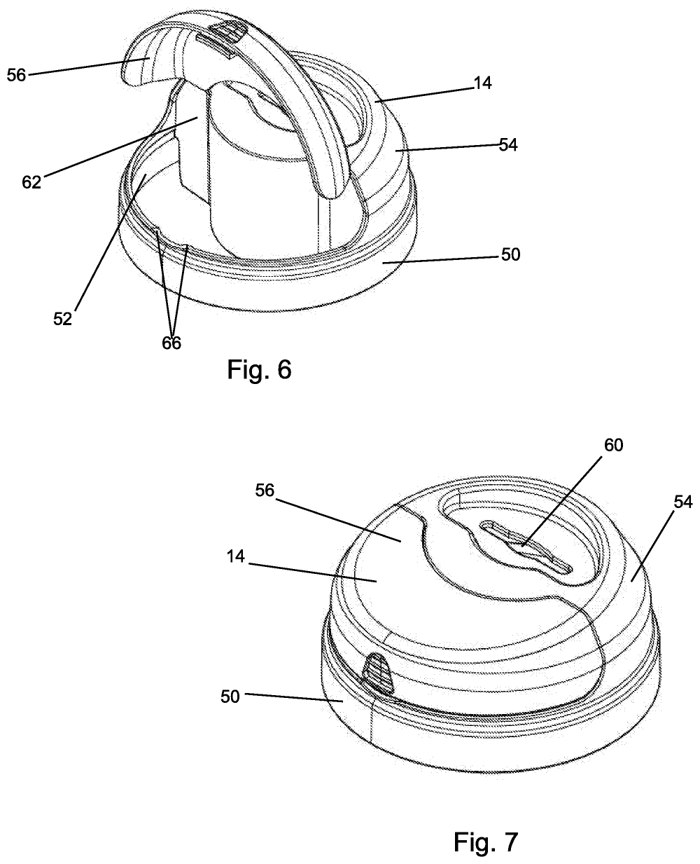

A package for an oral care device (such as a dental flosser) according to one embodiment of the present invention is shown in FIGS. 1-9 and generally designated 10. The package generally includes a container 12 and a lid 14. The lid 14 interfits on the container 12 to form an internal cavity 16. In one embodiment, the internal cavity 16 is divided into a dispensing cavity 18 and a disposal cavity 20. The lid includes a dispensing portion 22 and a disposal portion 24. The dispensing portion 22 provides selective access to the dispensing cavity 18 whereas the disposal portion 24 is in communication with the disposal cavity 20. As noted above, although the package may be used in connection with a variety of disposable oral care products, in the illustrated embodiment is it sized for use with dental flossers 13. Other such devices include, but are not limited to, toothpicks, interdental brushes, mini-brushes and flexible picks. These flossers 13 each include a handle 15, a pair of arms 17, 19 extending from the handle 15, and a strand of floss 21 extending between the arms 17, 19.

### II. Structure

In one embodiment, the container 12 includes a bottom 26 and an upwardly opening sidewall 28. As illustrated, the sidewall 28 is generally cylindrical; however, it may have a variety of shapes depending on the application. For example, the sidewall 28 may be cylindrical in situations where it is intended to be used in a cup holder. The sidewall 28 includes a bottom edge 30 and an upper edge 32. In the illustrated embodiment, the upper edge 32 defines an opening of the container 12. The container 12 may be formed from a variety of materials and in a variety of methods and in one embodiment is formed from injection molded plastic. Specifically, polyolefin plastics such as polypropylene and polyethylene are good materials for the living hinge and snap fits in the invention. In another embodiment, however, the container 12 may be manufactured by one of a variety of other methods, including blow molding, rotational molding, extrusion, casting, or additive manufacturing methods. The material hardness may vary, for example, from about 40 to about 90 Shore D. The container may have a range of sizes. In one embodiment, wherein the sidewall 28 is cylindrical, the container may have a diameter in the range of about 3 cm to about 10 cm and a height in the range of about 6 cm to about 20 cm (although these ranges may vary depending on the desired application). In an embodiment where the sidewall 28 is not cylindrical, the width and depth dimensions may range from about 3 cm to about 10 cm.

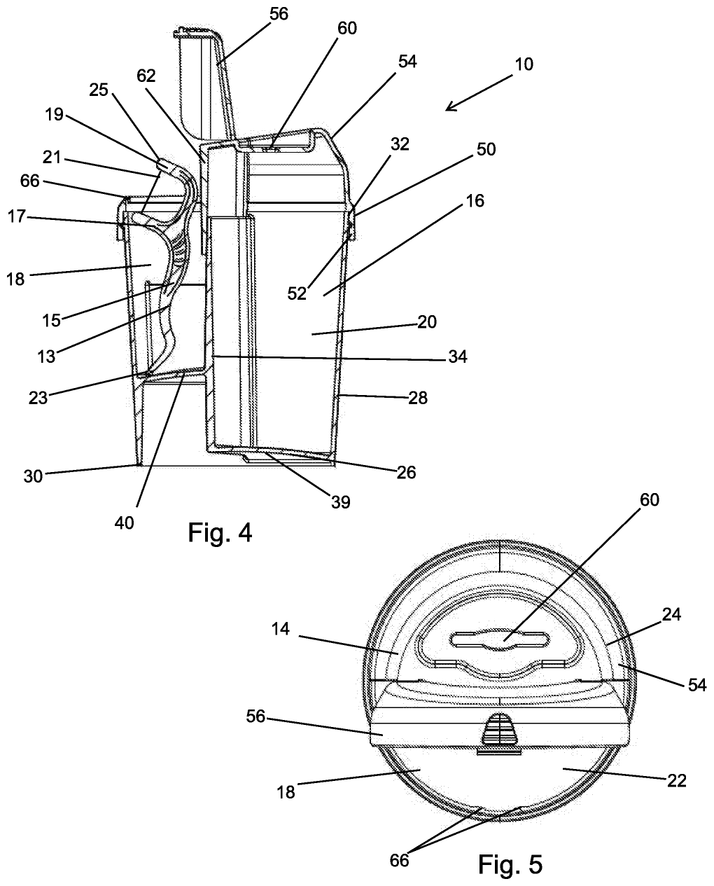

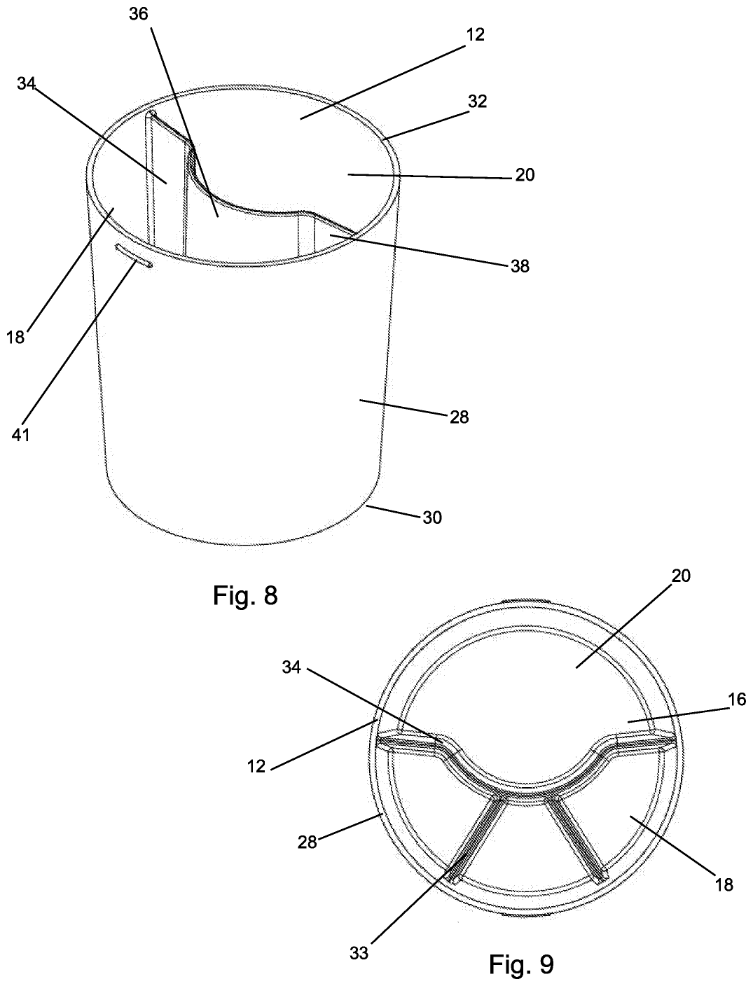

Referring to FIGS. 4, 8 and 9, the container 12 may be divided into two separate cavities. As illustrated, the container 12 is divided into a dispensing cavity 18 and a disposal cavity 20. The container 12 may be divided by a dividing wall 34. As shown in FIG. 8, the dividing wall 34 may substantially bisect the container 12, and may include a curved central wall portion 36 between a pair of peripheral wall portions 38 that abut the sidewall 28. Referring now to FIG. 4, the bottom 26 of the container 12 forms a lower enclosure for the container 12 and both cavities 18, 20. As shown, the bottom 26 has a first portion 39 within the disposal cavity 20 and a second portion 40 within the dispensing cavity 18. The second portion 40 may be positioned at a different height than the first portion 38 (i.e., with respect to the sidewall 28) in order to support the dental flossers 13 at a desired and convenient height with respect to the upper edge 32 of the sidewall 28 and to provide a larger cavity to receive used flossers, which are typically less organized in the cavity compared to the new flossers. As illustrated in FIG. 4, the dental flosser 13 includes a lower tip 23 and an upper tip 25 and defines a flosser length therebetween. The second portion 40 of the bottom 26 is spaced along the sidewall 28 such that the distance from the second portion 40 to the upper edge 32 of the sidewall is less than the flosser length to cause the upper tip 25 of the flossers 13 to project beyond the upper edge 32 for convenient access by the user. In another embodiment, the second portion 40 of the bottom may be spaced such that the upper tip 25 is flush with the upper edge 32 of the sidewall 26. In yet another embodiment, both portions 39, 40 of the bottom may be positioned at the same height with respect to the sidewall 28.

As shown in FIG. 1, unused flossers 13, or another type of oral care appliance, can be initially placed in the dispensing cavity 18 in a side-by-side stacked manner, such that the upper tip 25 of each flosser 13 extends above the upper edge 32 of the container 12. In one embodiment, shown in FIGS. 4 and 9, the dispensing cavity may include radial dividers 33 between which the flossers 13 are placed. The dividers 33 may act to hold the unused flossers 13 upright as individual flossers are removed by the user. They may also provide the container with a degree of rigidity.

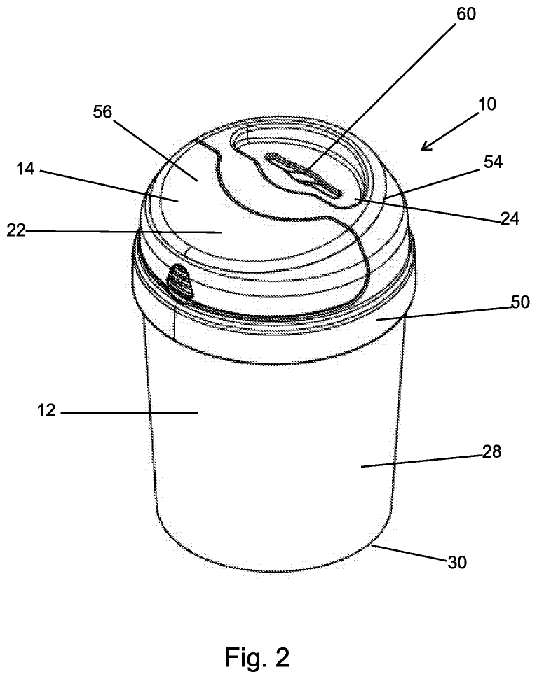

Referring now to FIGS. 1-7, the lid 14 covers the container 12 to form an internal cavity 16 while providing access to both the dispensing cavity 18 and the disposal cavity 20. The lid 14 generally includes an annular rim 50 having an inner surface 52 sized and shaped to interfit with the upper edge 32 of the container 12, for example, in the manner of a snap fit or a friction fit. In one embodiment, the rim 50 may snap fit onto a rib 41 on the container 12. A dome-shaped wall 54 extends upwardly from the rim 50. In one embodiment, the lid 14 includes a dispensing portion 22 and a disposal portion 24. The dispensing portion 22 includes a hinged cover 56 connected to the wall 54 such that it is pivotable between an open position such as that shown in FIGS. 1, 3, 4, 5 and 6 and a closed position such as that shown in FIGS. 2 and 7. As shown in FIG. 1, in the open position, the hinged cover 56 provides access to the dental flossers 13 within the dispensing cavity 18. As shown in FIG. 2, in the closed position the hinged cover 56 covers the dispensing cavity 18 and prevents access to the flossers 13. A latch 58 on the cover 56 may snap fit with a lip 66 on the rim 50 to hold the cover 56 in a closed position. The relative sizes of the latch 58 and the lip 66 may be predetermined in order to provide a desired lid opening force. In one embodiment, the lid opening force is between about 0 and 25 Newtons. In the illustrated embodiment, the hinged cover 56 connects to the wall 54 such that it pivots about a generally horizontal axis within a range of about 45 to about 270 degrees. In other words, the hinged cover 56 flips up when opened by the user. In another embodiment, the cover 56 could be hinged in a different location and thus open in a different direction. In yet another embodiment, the cover could be opened and closed in a different manner, such as a sliding or rotating mechanism.

The lid 14 additionally includes a structure enabling access to the disposal cavity 20. In the illustrated embodiment, the lid 14 includes a disposal portion 24 that defines a disposal opening or slot 60. The slot 60 is defined in the dome shaped wall 54 of the lid 14, such that it is positioned above the disposal cavity 20 when the lid 14 is positioned on the container 12. The slot 60 is sized such that one of the flossers 13 can be inserted into the slot 60 for deposit into the disposal cavity 20. In one embodiment, the slot is aligned vertically above the disposal cavity 20 when the lid 14 is positioned on the container 12, such that flossers 13 (or other oral care devices) can be dropped through the slot 60 and will fall into the disposal cavity 20. In another embodiment, the slot 60 may be positioned in another location on the lid 14 or the slot may be defined in the sidewall of the container 12 yet in communication with the disposal cavity 20 such that used flossers 13 can be inserted into the slot and into the disposal cavity 20.

In one embodiment, shown in FIGS. 4 through 6, the lid 14 includes a dividing wall 62 separating the dispensing portion 22 and the disposal portion 24. As illustrated, the dividing wall 62 extends downwardly from the wall 54 to maintain separation between the flossers 13 in the dispensing portion 22 and those inserted through the disposal slot 60. As shown in FIG. 4, the dividing wall 62 extends downwardly into an overlapping and abutting relationship with the wall 34 of the container 12, and in one embodiment the dividing wall 62 is curved to match the shape of the wall 36. In yet another embodiment, the container 12 and/or lid 14 may use a different structure to separate the unused flossers in the dispensing cavity 18 from the used flossers in the disposal cavity 20.

### III. Operation

In use, the package 10 may be filled by a manufacturer or assembler by inserting a stack of unused oral care devices, such as flosser 13, into the dispensing cavity 18 in the manner shown in FIG. 1, and then attaching the lid 14 to the container 12 by interfitting the rim 50 of the lid 14 onto the upper edge 32 of the container 12. Although in another embodiment, the package 10 may be sold to consumers empty, such that they may fill, or refill, the package 10 with a desired oral care product.

A user, wishing to conveniently make use of the flossers 13, may access an unused flosser 13 by opening the hinged cover 56 on the lid 14 to access the dispensing cavity 18 to remove one or more of the flossers 13. Given the design, this may be accomplished with one hand. After removing the one or more flossers 13, the user can close the hinged cover 56 to cover the remaining flossers 13. After using the one or more flossers 13, the user can dispose of them by inserting the used flossers 13 into the disposal slot 60 such that the used flossers fall into the disposal cavity.

### IV. Alternative Embodiment

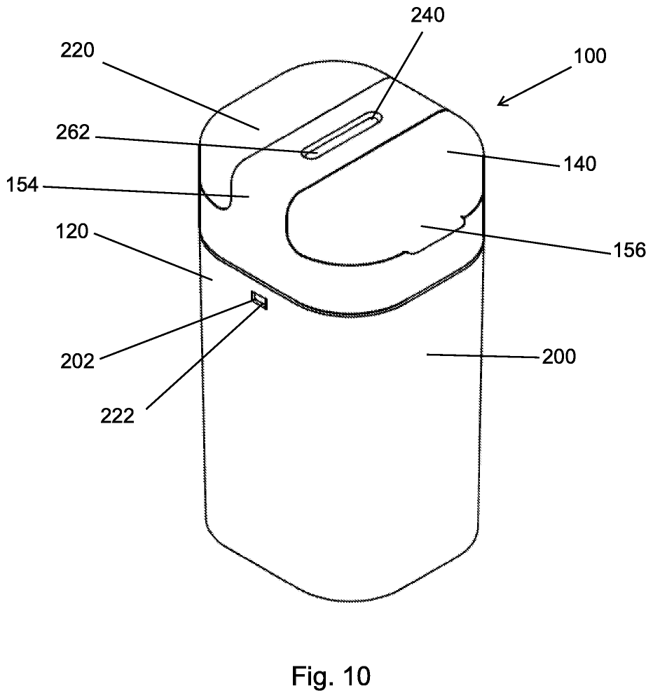

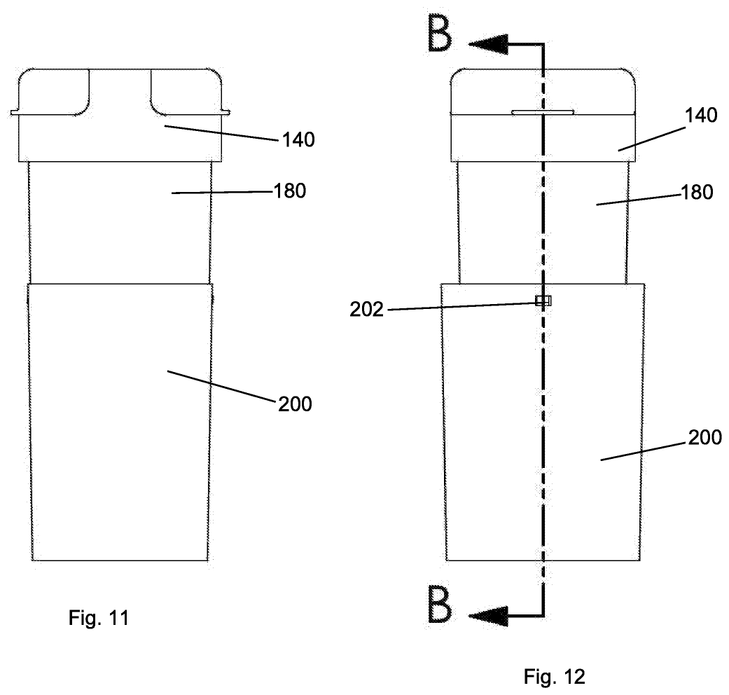

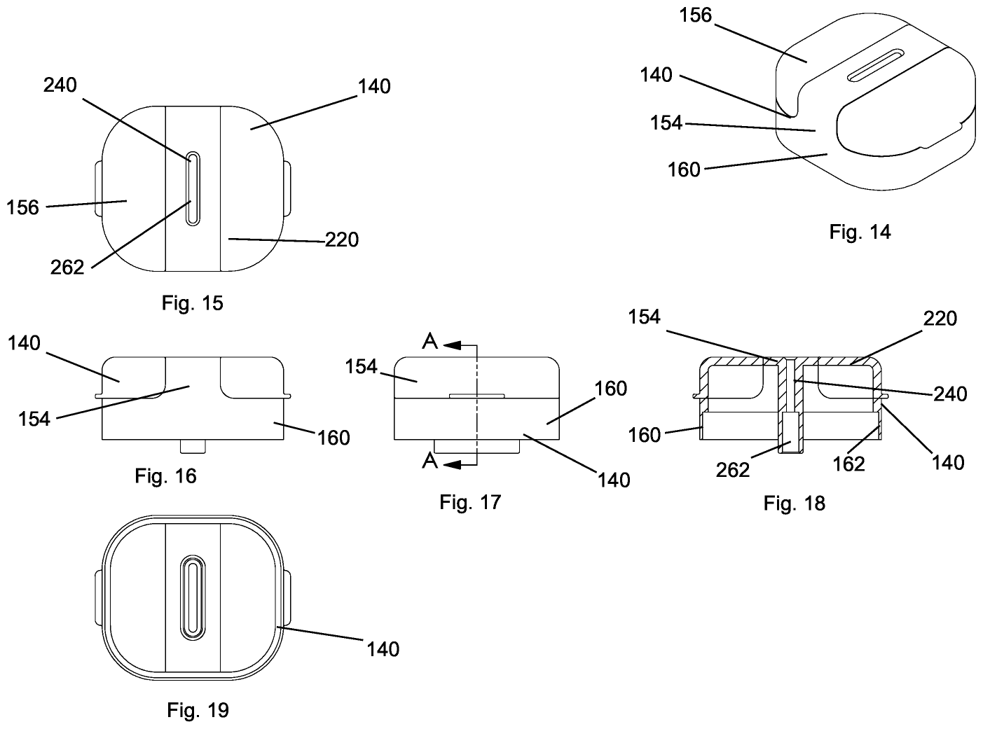

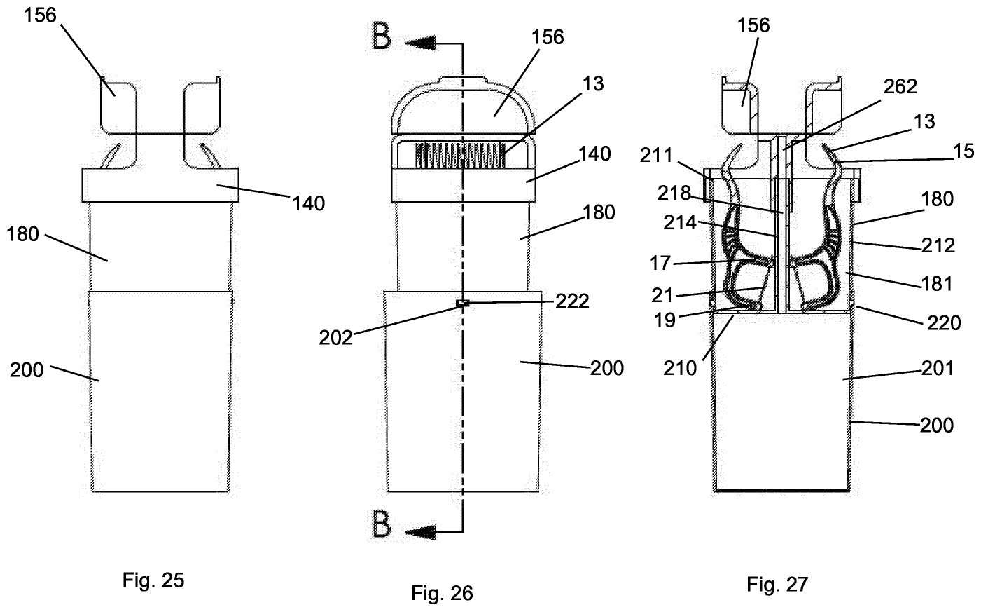

An alternative embodiment of the package 100 is illustrated in FIGS. 10-27. In this embodiment, the container 120 generally includes both a dispensing container 180 defining the dispensing cavity 181 and a disposal container 200 defining the disposal cavity 201. The dispensing container 180 is stacked or nested into the disposal container 200 and can be moved between a fully nested, packaged position (FIG. 10) and a partially nested use position (FIGS. 11-13 and 24-27). The dispensing container 180 is positioned above the disposal container 200. Similar to the first embodiment, a lid 140 interfits on the dispensing container 180 and the lid includes a dispensing portion 220 and a disposal portion 240. The dispensing portion 220 provides selective access to the dispensing cavity 181 whereas the disposal portion 240 is in communication with the disposal cavity 201. As noted above, although the package 100 may be used in connection with a variety of disposable oral care products, in the illustrated embodiment is it sized for use with dental flossers 13, which are generally the same as those described in connection with the first embodiment and therefore will not be described again in detail. As in the first embodiment, these flossers 13 each include a handle 15, a pair of arms 17, 19 extending from the handle 15, and a strand of floss 21 extending between the arms 17, 19.

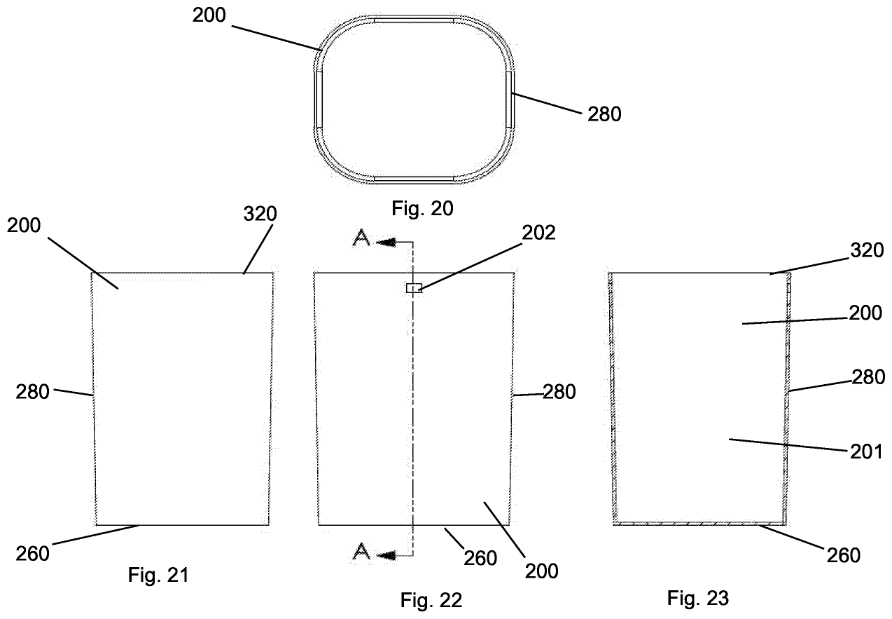

Referring particularly to FIGS. 20-23, the disposal container 200 includes a bottom 260 and a sidewall 280 extending upwardly from the sidewall 280. The sidewall 280 includes an upper edge 320 that defines an opening of the disposal cavity 201. As illustrated, the sidewall 280 is substantially a rounded rectangle in shape, although other shapes may be used depending on the desired application. In one embodiment, the disposal container 200 includes structure for releasably attaching the dispensing container 180 when it is stacked within the disposal container 200. As illustrated, the attachment structure includes a pair of cutouts 202 in opposing walls of the disposal container 200.

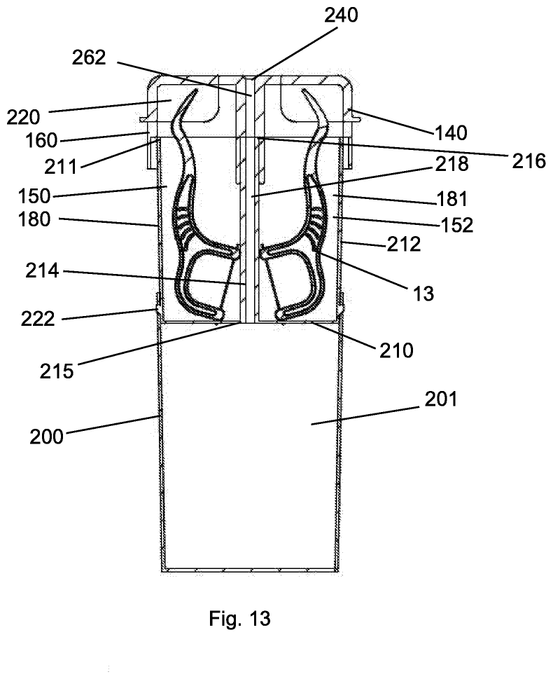

As shown in FIGS. 10-13, the dispensing container 180 is sized and shaped to nest within the disposal container 200. FIG. 10 shows the dispensing container 180 in a fully nested position within the disposal container 200, whereas FIGS. 11-13 and 24-27 show the dispensing container 180 in a raised, partially nested position within the disposal container 200. As discussed in more detail below, the raised position is a “use” position that creates space within the disposal cavity 201 for used flossers 13 or other oral care devices. In one embodiment, the dispensing container 180 includes a floor 210 and a sidewall 212 extending upwardly from the floor 210 to an upper edge 211. The sidewall 212 of the dispensing container 180 may be sized and shaped to nest relatively snugly within the sidewall 280 of the disposal container 200. The dispensing container 180 forms a dispensing cavity 181 that is sized to retain a desired number of flossers 13. As shown in FIG. 13, the disposal cavity 181 is sized with a predetermined height between the floor 210 and the upper edge 211 to receive dental flossers 13 with the handle 15 extending beyond the upper edge 211 of the dispensing container 180 for convenient removal of the flossers 13. In one embodiment, the dispensing container includes a pair of opposing retention tabs 222 that extend outwardly from the sidewall 212.

Referring now to FIG. 13, a disposal receptacle 214 extends upwardly from the floor 210 from a base end 215 to an upper end 216. In the illustrated embodiment, the upper end 216 is at about the same height as the upper edge 211 of the dispensing container sidewall 212. The receptacle 214 forms an internal slot 218 extending between the upper end 216 through the floor 212, which is capable of receiving used flossers 13 that are inserted into the upper end 216 of the receptacle to pass the used flossers 13 through the slot 218 and into the disposal cavity 201. The shape and size of the receptacle 214 may vary depending on the shape and size of the flosser 13 or other oral care device to be used in connection with the container 100. In one embodiment, the receptacle 214 extends across the dispensing container 180, forming a wall that divides the cavity into two opposing sections 150, 152.

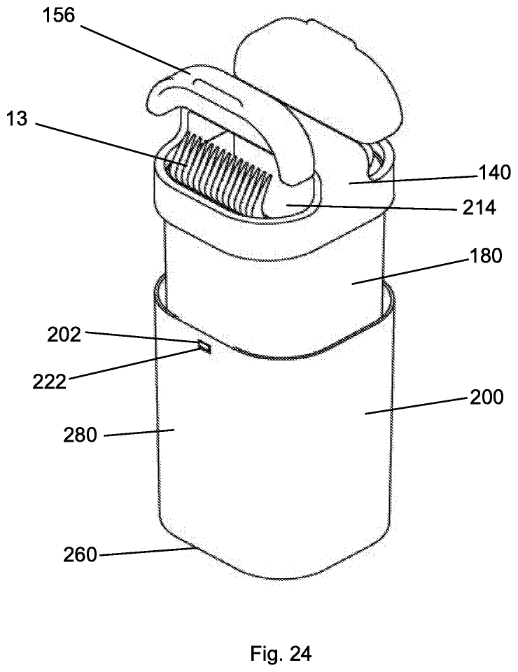

FIGS. 10-19 show a dispensing lid 140 that, as shown in FIG. 13, fits on top of the upper edge 211 of the dispensing container 180 to close the dispensing cavity 181. The lid 140 generally includes an annular rim 160 having an inner surface 162 sized and shaped to interfit with the upper edge 211 of the dispensing container 180 for example, in the manner of a snap fit or a friction fit. A dome-shaped wall 154 extends upwardly from the rim 160. The dispensing portion 220 of the lid 14 includes at least one hinged cover 156 connected to the wall 154 such that it is pivotable between an open position such as that shown in FIGS. 24-27 and a closed position such as that shown in FIGS. 10-13. In the illustrated embodiment, the lid 140 includes two independently pivotable hinged covers 156. As shown in FIG. 24, in the open position, the hinged cover 156 provides access to the dental flossers 13 within the dispensing cavity 181. As shown in FIG. 13, in the closed position the hinged covers 156 cover the dispensing cavity 181 and prevent access to the flossers 13. In the illustrated embodiment, the hinged covers 156 connect to the wall 154 such that each hinged cover 156 pivots about a generally horizontal axis. In other words, the hinged covers 156 flip up when opened by the user. In another embodiment, one or more covers 156 could be hinged in a different location and thus open in a different direction. In yet another embodiment, one or more covers could be opened and closed in a different manner, such as a sliding or rotating mechanism.

Similar to the first embodiment, the lid 140 additionally includes a structure enabling access to the disposal cavity 201. In the illustrated embodiment, the lid 140 includes a disposal portion 240 that defines a disposal slot or opening 262. The slot 262 is defined in the dome shaped wall 154 of the lid 140, such that it is positioned above the disposal cavity 201 when the lid 140 is positioned on the container 120. The slot 262 is sized such that one of the flossers 13 can be inserted into the slot 262 for deposit into the disposal cavity 201. In one embodiment, the slot is aligned vertically above the disposal cavity 201 and generally in the center of the lid 140, such that flossers 13 (or other oral care devices) can be dropped through the slot 262 and will fall through the disposal receptacle 214 in the dispensing container 180 and then into the disposal cavity 201. The slot 262 and receptacle 214 combine to place the disposal portion 240 of the lid 140 in communication with the disposal cavity 201.

In use, the package 100 of this alternative embodiment may be filled by a manufacturer or assembler by inserting a stack of unused oral care devices, such as flosser 13, into the dispensing container 180 in the manner shown in FIGS. 13 and 24, and then attaching the lid 140 to the container 120 by interfitting the rim 160 of the lid 140 onto the upper edge 211 of the dispensing container 180. In general, the package 100 is delivered to retailers and sold in with the containers 180, 200 in the nested position shown in FIG. 10, such that the overall package minimizes shelf space.

A user, wishing to conveniently make use of the flossers 13, may access an unused flosser 13 by opening one of the hinged covers 156 on the lid 140 to access the dispensing cavity 181 to remove one or more of the flossers 13. Given the design, this may be accomplished with one hand. After removing the one or more flossers 13, the user can close the hinged cover 156 to cover the remaining flossers 13. Either before or after using the flossers, the user may slide the dispensing container 180 upwardly with respect to the disposal container 200, rotate 90 degrees and then engage the retention tabs 222 in the cutouts 202 to hold the dispensing container 180 in the partially nested position shown in FIGS. 11-13 and 24-27 to create space within the disposal cavity 201. After using the one or more flossers 13, the user can dispose of them by inserting the used flossers 13 into the disposal slot 262 such that the used flossers fall into the disposal cavity 201. Alternative variations of the lid 140 may also be incorporated into the dispensing package 100, such as a single lid that selectively opens and closes to provide access to both the dispensing 181 and disposal 201 cavities, a rotating lid that selectively opens and closes access to the dispending and disposal cavities in the manner of a salt dispensing package, or a single lid that covers only the dispending portion, leaving the disposal portion generally uncovered.

The above description is that of the current embodiments of the invention. Various alterations and changes can be made without departing from the spirit and broader aspects of the invention.

1. A flosser package comprising:
a container having a bottom and a sidewall extending from the bottom and forming a cavity;
a plurality of flossers within said cavity, each said flosser including a handle, a pair of flosser arms extending from said handle, and a strand of floss extending between said flosser arms;
a lid covering said at least a portion of said cavity, said lid including a dispensing portion and a disposal portion separate from said dispensing portion, said dispensing portion selectively providing access to said flossers within said cavity, said disposal portion including a disposal slot in communication with said cavity and capable of receiving one of said flossers.

2. The flosser package of claim 1 wherein said cavity includes a dispensing cavity and a disposal cavity divided from said dispensing cavity, wherein said plurality of flossers is disposed within said dispensing cavity and wherein said disposal slot is in communication with said disposal cavity.

3. The flosser package of claim 2 wherein said lid dispensing portion is hinged to provide said selective access to said dispensing cavity, said lid dispensing portion movable between an open position providing access to said dispensing cavity and a closed position covering said dispensing cavity.

4. The flosser package of claim 3 wherein said container includes a container wall separating said dispensing cavity from said disposal cavity.

5. The flosser package of claim 4 wherein said lid includes a lid wall, said dispensing portion on a first side of said lid wall, said disposal portion on a second side of said lid wall.

6. The flosser package of claim 5 wherein said lid wall aligns with said container wall when said rim of said lid is interfitted with said upper edge of said container.

7. The flosser package of claim 6 wherein said bottom of said container within said dispensing cavity is positioned to support said plurality of flossers such that a portion each of said flossers is at or above said upper edge of said container sidewall.

8. The flosser package of claim 3 wherein said container includes a dispensing container defining said dispensing cavity and a disposal container defining said disposal cavity.

9. A package for oral care devices, comprising:
a container having a dispensing portion and a disposal portion; and
a lid covering said container and having a first portion aligned above said dispensing portion and a second portion aligned above said disposal portion, said first portion capable of being opened to enable a user to access one or more of the oral care devices within the dispensing portion, and closed to cover the dispensing portion and prevent access to the one or more oral care devices.

10. The package of claim 9 wherein said lid includes a disposal slot defined in said second portion, said disposal slot in communication with said disposal portion of said container.

11. The package of claim 10 wherein said dispensing portion and said disposal portion are completely separate.

12. The package of claim 11 wherein said package includes a wall dividing said dispensing portion from said disposal portion.

13. The package of claim 12 wherein container includes a bottom and wherein at least a portion of said wall extends upwardly from said bottom.

14. The package of claim 13 wherein at least a portion of said wall extends from said lid.

15. The package of claim 14 wherein said second portion of said lid is fixed.

16. The package of claim 14 wherein the oral care devices are flossers, said flossers including a strand of dental floss extending between first and second arms.

17. The package of claim 11 wherein said container includes a dispensing container defining said dispensing cavity and a disposal container defining said disposal cavity.

18. A package for dental flossers, comprising:
a generally cylindrical container having a bottom and a sidewall, said sidewall having an upper edge forming an opening of said container;
a lid covering said container to form an internal cavity, said lid including a rim interfitted with said upper edge of said container to cover said opening, said lid including a hinged dispensing portion that can be pivoted between a closed position and an open position, said lid including a disposal slot separate from said dispensing portion; and
a divider that divides said internal cavity into a dispensing cavity and a disposal cavity, said dispensing portion of said lid positioned to provide access to said dispensing cavity when said dispensing portion is in said open position and to cover said dispensing cavity when said dispensing portion is in said closed position, said disposal slot positioned in communication with said disposal cavity.

19. The package of claim 18 including a plurality of dental flossers arranged in said dispensing cavity.

20. The package of claim 19 wherein said bottom of said container within said dispensing cavity is positioned such that at least a portion of each of said plurality of dental flossers extends above said upper edge of said container.

21. The package of claim 20 wherein a lower portion of said divider is attached to said container and an upper portion of said divider is attached to said lid.
